(19) United States
(12) Patent Application Publication
(10) Pub. No.: US 2025/0290695 A1
(43) Pub. Date: Sep. 18, 2025

(54) Cylinder for Drying a Fibrous Web

(71) Applicant: ANDRITZ AG, Graz (AT)

(72) Inventors: Wolfgang Kraft, St. Aegyd am Neuwalde (AT); Roland Hak, Dürnstein (AT)

(21) Appl. No.: 18/860,043

(22) PCT Filed: Feb. 8, 2023
(86) PCT No.: PCT/EP2023/053121

§ 371 Date: Oct. 25, 2024

(30) Foreign Application Priority Data
May 3, 2022 (AT) A50302/2022

(51) Int. Cl. F26B 13/18

(52) U.S. Cl. CPC F26B 13/183

(57) ABSTRACT

A cylinder for drying a fibrous web has a cylinder shell, wherein an electric heating device for heating the cylinder is arranged inside the cylinder. The electric heating device is arranged on the inside of the cylinder shell, forming a conductive thermal connection, wherein the electric heating device comprises at least one electric heating element with carbon nanotubes. This provides a cylinder with a heating device with improved efficiency.

### BACKGROUND

The disclosed embodiments relate to a cylinder for drying a fibrous web, comprising a cylinder shell with an outer side for guiding the fibrous web to be dried and an inner side, wherein an electric heating device for heating the cylinder is arranged inside the cylinder.

In pulp and paper production, a fibrous web is typically dried using steam-heated cylinders. Steam-heated cylinders are characterized by high heat output. This ensures a uniform temperature distribution on the cylinder surface, although the edge area of the cylinder shell is often overheated. Steam-heated cylinders must be designed as pressurized vessels, which means that the cylinder walls are thicker, which is detrimental to heat transfer. The actual steam production takes place as part of the combustion process and is therefore criticized for ecological reasons. Steam cylinders can be combined into groups, whereby the individual group is characterized by a certain steam pressure or a certain temperature. This makes it possible to profile drying in the machine direction by adjusting the heat output of the individual groups accordingly. However, it is not possible to profile the drying process in the transverse direction of the machine using the steam-heated cylinders.

Infrared dryers, which are characterized by radiant heat transfer and dispense with heat transfer based on direct heat conduction, are also well known. Such infrared dryers include gas-powered dryers as well as electrically powered radiators.

U.S. Pat. No. 3,624,353A discloses a drying cylinder for paper webs comprising a cylindrical shell having a plurality of axial annular regions arranged along the inner surface of the shell, the annular regions comprising an electrical resistor and an adjustable electrical current being suppliable to the resistor to provide an axial temperature gradient.

Furthermore, DE 1020 1320 4009 A1 discloses a heating device comprising a carrier layer and a heating layer, wherein the thin heating layer is positioned on the carrier layer and the carrier layer is designed to be thermally insulating. This solution makes it possible to reduce the energy requirement by reducing the masses to be heated.

### SUMMARY

Provided herein is a cylinder for drying a fibrous web with an electric heating device with improved efficiency. The disclosed embodiments further provide improved profile control of the heat transfer through the cylinder.

As disclosed herein, this is achieved in that the electric heating device is arranged on the inside of the cylinder shell, forming a conductive thermal connection, the electric heating device comprising at least one electric heating element with carbon nanotubes. By arranging the electric heating device directly on the inside of the cylinder shell, forming a conductive thermal connection, energy losses are avoided and the maximum available surface area is utilized for heat exchange between the cylinder shell and the heating jacket. However, in the case of heating elements that are arranged at a distance from the inner surface of the cylinder shell, the heat flux density between the heating element and the cylinder shell is reduced. It has also been recognized that the heat flows required for drying can be achieved when the heating device is in direct contact with the inside of the cylinder shell—i.e. when a conductive thermal connection is formed. It was also recognized that the use of an electric heating element comprising carbon nanotubes would allow greater heat flows to be achieved, with excellent thermal conductivity and, in particular, improved efficiency of heat utilisation from electricity. This allows the required temperatures of 90° C.-130° C. to be displayed on the outside of the cylinder shell. Typically, the cylinder is made of steel or cast iron, as steel and cast iron have favourable properties in terms of thermal conductivity and mechanical strength. This makes it possible to realize thin-walled cylinders that can withstand mechanical stresses and have good heat transfer. Cylinder diameters in the range between 1500 mm and 1800 mm with wall thicknesses of less than 30 mm or less than 25 mm are also typical.

An advantageous design of the cylinder is characterized by the fact that the electric heating device, in particular the at least one electric heating element, is materially bonded to the inside of the cylinder shell and in particular glued, or is force-locked, in particular is pressed against the inside of the cylinder shell. In both cases, a favourable heat transfer is ensured, whereby the heat transfer is reliable, precise, and uniform.

In a further advantageous embodiment, the at least one electric heating element is designed as a heating mat. The heating mat is designed to allow the entire inside of the cylinder shell to be quickly and easily covered.

In an equally advantageous design of the cylinder, the heating mat essentially consists of silicone with embedded carbon nanotubes. Such heating mats allow a homogeneous temperature distribution, whereby a particularly homogeneous temperature distribution can be achieved by arranging several heating mats side by side.

A further advantageous design of the cylinder is characterized in that the electric heating device comprises an insulation, wherein the at least one electric heating element is arranged between the insulation and the inside of the cylinder shell. The advantageous arrangement of the insulation makes it possible to avoid heat losses, with the heat being transported primarily from the heating element towards the inside of the cylinder shell. The insulation of the heating device can be designed to replace or supplement the familiar cylinder end cover insulation.

Equally advantageous is an embodiment of the cylinder, wherein the heating device comprises at least a first and a second zone, and the zones each comprise at least one electric heating element with carbon nanotubes, wherein the zones are arranged in the axial direction of the cylinder on the inside of the cylinder shell, and a first heating power of the first zone is adjustable independently of a second heating power of the second zone. In terms of distribution, the invention allows a profile control of the heat transfer through the cylinder in the axial direction. If the electric heating elements are arranged in an axial direction, the axial profile can be adjusted by specifically setting the first or second heating power. The course of the surface temperature of the cylinder can thus be easily controlled with the disclosed embodiments.

An advantageous design of the cylinder is characterized by the fact that end covers connected to the cylinder shell on the end face are included, whereby a connection for supplying the electric heating device with electrical current is routed through at least one end cover. Since the cylinder is typically rotatable and the power is supplied via a non-rotatable environment, the connection for supplying the electric heating device with electrical current is advantageously routed through at least one end cover. For example, the end cover can also have a journal, with the connection for the supply passing through the journal. Advantageously, the connection further comprises a slip ring body that moves with the cylinder, wherein the slip ring body is designed to receive electric current. For example, stationary contact pins can be arranged in the area of the non-rotatable surroundings, which are in contact with the slip ring body in order to establish an electrical connection between the heating device and an electrical power source.

Also disclosed herein is a cylinder group comprising at least a first and a second cylinder according to the disclosed embodiments, wherein the electric heating device of the first cylinder is controllable independently of the electric heating device of the second cylinder. Advantageously, the first and second cylinders are independent of each other.

### BRIEF DESCRIPTION OF THE DRAWING

FIG. 1 is a partial cross-sectional view of an embodiment of the disclosed cylinder.

### DETAILED DESCRIPTION

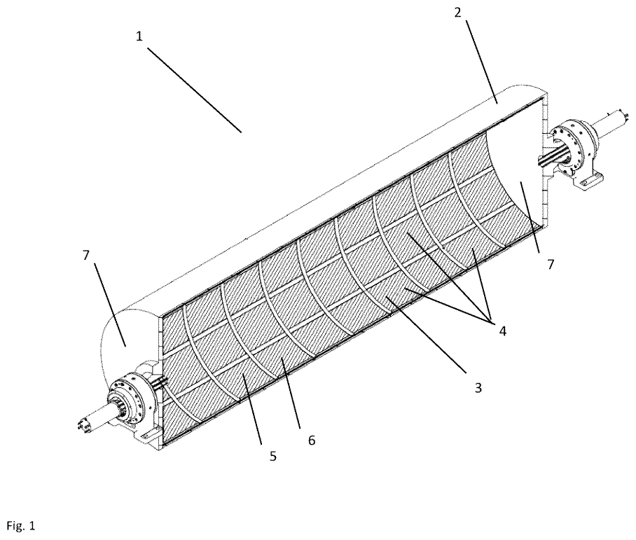

The inventive embodiments are now described with reference to FIG. 1. FIG. 1 shows a cylinder 1 according to the disclosure for drying a fibrous web with a cylinder shell 2. A fibrous web to be dried can be guided on the outside of the cylinder shell 2. An electric heating device 3 for heating the cylinder 1 is arranged inside the cylinder 1, wherein the electric heating device 3 is arranged on the inside of the cylinder shell 2, forming a conductive thermal connection, and the electric heating device 3 comprises at least one electric heating element 4 with carbon nanotubes. Advantageously, the at least one electric heating element 4 is designed as a heating mat, whereby the heating mats in particular can be installed very easily on the inside of the shell 2. Equally advantageous is if the heating device 3 comprises at least a first and a second zone 5,6, and the zones 5,6 are arranged offset in axial direction of the cylinder on the inside of the cylinder shell, and a first heating power of the first zone 5 is adjustable independently of a second heating power of the second zone 6. This allows zonal control and thus cross-profiling of the cylinder's heating output. The cylinder 1 can be designed with an end cover 7, whereby the end covers 7 are connected to the cylinder shell 2 at the end face. Advantageously, the electric heating device 3 is supplied with electric current via a connection that is routed through at least one end cover. Typically, the connection also comprises a slip ring body that moves with the cylinder 1 and is designed to carry electrical current.

The disclosed embodiments offer numerous advantages, in particular the cylinder has an electric heating device with improved efficiency, whereby the heat flows necessary for drying a fibrous web can be realised. Accordingly, a homogeneous temperature distribution on the outside of the cylinder shell can be set, but axial profiling of the heat transfer through the cylinder is also possible. In particular, the electric heating elements designed as heating mats are easy to install.

### REFERENCE NUMERALS

1 Cylinder
2 Cylinder shell
3 Electric heating device
4 Electric heating element
5 First zone
6 Second zone
7 End cover

1-10. (canceled)

11. A cylinder (1) for drying a fibrous web, comprising
a cylinder shell (2) with an outer side for guiding the fibrous web to be dried and an inner side;
an electric heating device (3) arranged on the inner side of the cylinder shell (2) and configured for heating the cylinder (1) forming a conductive thermal connection, wherein
the electric heating device (3) comprises at least one electric heating element (4) with carbon nanotubes and is configured to generate a temperature within an approximate range of 90° C.-130° C. on the outer side of the cylinder shell.

12. The cylinder (1) according to claim 11, wherein the electric heating device (3) is bonded to the inner side of the cylinder shell (2).

13. The cylinder (1) according to claim 12, wherein the electric heating device (3) is bonded to the inner side of the cylinder shell (2) via gluing the at least one electric heating element (4) to the inner side.

14. The cylinder (1) according to claim 11, wherein the electric heating device (3) is non-positively connected to the inner side of the cylinder shell (2).

15. The cylinder (1) according to claim 14, wherein the electric heating device (3) is non-positively connected to the inner side of the cylinder shell (2) via the at least one electric heating element (4) being pressed against the inner side of the cylinder shell (2).

16. The cylinder (1) according to claim 11, wherein the at least one electric heating element (4) is designed as a heating mat.

17. The cylinder (1) according to claim 16, wherein the heating mat comprises silicone with embedded carbon nanotubes.

18. The cylinder (1) according to claim 16, wherein the heating mat consists essentially of silicone with embedded carbon nanotubes.

19. The cylinder (1) according to claim 11, wherein
the electric heating device (3) further comprises insulation, and
the least one electric heating element (4) is arranged between the insulation and the inner side of the cylinder shell (2).

20. The cylinder (1) according to claim 14, wherein
the electric heating device (3) further comprises insulation, and
the least one electric heating element (4) is arranged between the insulation and the inner side of the cylinder shell (2).

21. The cylinder (1) according to claim 11, wherein
the electric heating device (3) comprises at least a first zone (5) and a second zone (6),
each of the first zone (5) and the second zone (6) comprises at least one electric heating element (4) with carbon nanotubes,
the first zone (5) and second zone 96) are arranged offset from each other in an axial direction of the cylinder on the inner side of the cylinder shell (2), and
a first heating power of the first zone (5) is adjustable independently of a second heating power of the second zone (6).

22. The cylinder (1) according to claim 17, wherein
the electric heating device (3) comprises at least a first zone (5) and a second zone (6),
each of the first zone (5) and the second zone (6) comprises at least one electric heating element (4) with carbon nanotubes,
the first zone (5) and second zone 96) are arranged offset from each other in an axial direction of the cylinder on the inner side of the cylinder shell (2), and
a first heating power of the first zone (5) is adjustable independently of a second heating power of the second zone (6).

23. The cylinder (1) according to claim 12, wherein
the electric heating device (3) comprises at least a first zone (5) and a second zone (6),
each of the first zone (5) and the second zone (6) comprises at least one electric heating element (4) with carbon nanotubes,
the first zone (5) and second zone 96) are arranged offset from each other in an axial direction of the cylinder on the inner side of the cylinder shell (2), and
a first heating power of the first zone (5) is adjustable independently of a second heating power of the second zone (6).

24. The cylinder (1) according to claim 14, wherein
the electric heating device (3) comprises at least a first zone (5) and a second zone (6),
each of the first zone (5) and the second zone (6) comprises at least one electric heating element (4) with carbon nanotubes,
the first zone (5) and second zone 96) are arranged offset from each other in an axial direction of the cylinder on the inner side of the cylinder shell (2), and
a first heating power of the first zone (5) is adjustable independently of a second heating power of the second zone (6).

25. The cylinder (1) according to claim 21, further comprising end covers (7) connected to the cylinder shell (2) on the end face, wherein a connection for supplying the electric heating device (3) with electrical current is routed through at least one end cover (7).

26. The cylinder (1) according to claim 11, further comprising end covers (7) connected to the cylinder shell (2) on the end face, wherein a connection for supplying the electric heating device (3) with electrical current is routed through at least one end cover (7).

27. The cylinder (1) according to claim 25, wherein the connection comprises a slip ring body that moves with the cylinder (1) and the slip ring body is designed to carry electric current.

28. A group of cylinders, comprising at least a first cylinder (1) and a second cylinder (1) each according to claim 11, wherein the electric heating device (3) of the first cylinder (1) is operated independently of the electric heating device (3) of the second cylinder (1).
